(19) United States
(12) Patent Application Publication
(10) Pub. No.: US 2015/0210818 A1
(43) Pub. Date: Jul. 30, 2015

(54) CRYOGENIC INSULATION FOAM

(71) Applicant: E I DU PONT DE NEMOURS AND COMPANY, Wilmington, DE (US)

(72) Inventor: GARY LOH, NEWARK, DE (US)

(21) Appl. No.: 14/591,335

(22) Filed: Jan. 7, 2015

Related U.S. Application Data
(60) Provisional application No. 61/931,758, filed on Jan. 27, 2014.

(51) Int. Cl. C08J 9/14; C08G 18/76; C08G 18/42; C08G 18/08

(52) U.S. Cl. CPC C08J 9/146; C08G 18/14; C08G 18/7664; C08G 18/42; C08J 9/144; C08J 9/141; C08J 2207/00; C08J 2375/06; C08J 2203/14; C08J 2203/162

(57) ABSTRACT

The disclosure herein relates to cryogenic insulation foam compositions comprising a fluoroolefin blowing agent. These foams have good insulation properties at −196° C., and comprise blowing agents that contain cis- or trans-1,1,1,4,4,4-hexafluoro-2-butene or 1-chloro-3,3,3-trifluoro-1-propene.

### FIELD OF THE INVENTION

The disclosure herein relates to cryogenic insulation foam compositions comprising a fluoroolefin blowing agent. In particular, the present disclosure relates to cryogenic insulating foam compositions comprising blowing agents including cis-1,1,1,4,4,4-hexafluoro-2-butene, 1-chloro-3,3,3-trifluoro-1-propene, or both.

### BACKGROUND OF THE INVENTION

Closed-cell polyisocyanate-based foams are widely used for insulation purposes, for example, in building construction and in the manufacture of energy efficient electrical appliances. However, at cryogenic temperatures, foams lose their insulating capabilities, become structurally compromised or inflexible due to the extremely low temperatures. Cryogenic insulation is particularly important for the storage, transportation and handling of liquefied gases such as liquid nitrogen (LN) or liquid oxygen (LOX). Vacuum containers are sometimes used for small amounts but this requires expensive, heavy steel containers. Spun fiberglass may be used, but it is bulky, and may lose flexibility. Insulation at the joints of pipelines and containers where expansion/contraction may occur is particularly difficult. Although polyurethane foams are widely used for a variety of applications these foams typically have limited use in cryogenic applications.

Insulating foams depend on the use of halocarbon blowing agents, not only to foam the polymer, but primarily for their low vapor thermal conductivity, a very important characteristic for insulation value. Historically, polyurethane foams used CFCs (chlorofluorocarbons, for example CFC-11, trichlorofluoromethane) and HCFCs (hydrochlorofluorocarbons, for example HCFC-141b, 1,1-dichloro-1-fluoroethane) as the primary blowing agent. However, due to the implication of chlorine-containing molecules such as the CFCs and HCFCs in the destruction of stratospheric ozone, the production and use of CFCs and HCFCs has been restricted by the Montreal Protocol. More recently, hydrofluorocarbons (HFCs), which do not contribute to the destruction of stratospheric ozone, have been employed as blowing agents for polyurethane foams. An example of an HFC employed in this application is HFC-245fa (1,1,1,3,3-pentafluoropropane). The HFCs do not contribute to the destruction of stratospheric ozone, but are of concern due to their contribution to the “greenhouse effect”, i.e., they contribute to global warming. As a result of their contribution to global warming, the HFCs have come under scrutiny, and their widespread use may also be limited in the future.

Japanese Patent No. 05179043 discloses the use of cis-1,1,1,4,4,4-hexafluoro-2-butene as the blowing agent together with highly compatible polyether polyols to form polyurethane foams.

### SUMMARY OF THE INVENTION

There is need for cryogenic insulating foams that provide low flammability and exceptional thermal insulation at low and cryogenic temperatures. In addition, this cryogenic insulation should comprise a blowing agent that has substantially low ozone depletion potential (ODP) and very low global warming potential (GWP). Accordingly, this disclosure provides cryogenic insulating foams comprising blowing agent that include a fluoroolefin. These fluoroolefins include cis-1,1,1,4,4,4-hexafluoro-2-butene or 1-chloro-3,3,3-trifluoro-1-propene. The blowing agent may also include a hydrocarbon, such as methyl formate, n-pentane, isopentane, or cyclopentane.

This disclosure also provides a method for producing a cryogenic insulation polyurethane or polyisocyanurate polymer foam. The method comprises reacting an effective amount of the foam-forming composition and a suitable polyisocyanate, where the foam forming composition comprises a fluoroolefin and a second component such as a hydrocarbon.

### DETAILED DESCRIPTION

The composition of this disclosure is a cryogenic insulation comprising a polyurethane foam made from a foam-forming composition comprising cis-1,1,1,4,4,4-hexafluoro-2-butene and an active hydrogen-containing compound having two or more active hydrogens, in the form of hydroxyl groups. In this disclosure, blends of foam expansion agents including cis-1,1,1,4,4,4-hexafluoro-2-butene or 1-chloro-3,3,3-trifluoro-1-propene, or both, are used as cryogenic foam blowing agents.

By “cryogenic”, it is meant to refer to conditions of very low temperature. Cryogenic temperatures are typically about or below about −196° C.

By “cream time”, it is meant to refer to the time period starting from the mixing of the active hydrogen-containing compound with polyisocyanate, and ending at when the foaming starts to occur and color of the mixture starts to change.

By “rise time”, it is meant to refer to the time period starting from the mixing of the active hydrogen-containing compound with polyisocyanate, and ending at when the foam rising stops.

By “tack free time”, it is meant to refer to the time period starting from the mixing of the active hydrogen-containing compound with polyisocyanate, and ending at when the surface of the foam is no longer tacky.

By “initial k-value”, it is meant to refer to the polymer foam's thermal conductivity measured at a mean temperature of −165° C. (−265° F.) using Test Method ASTM C518 (ISO 8301).

The thermoset polyurethane cryogenic insulating foams of the present invention are made by reacting an active hydrogen-containing compound with a polyisocyanate.

The active hydrogen-containing compounds include compounds having two or more groups that contain an active hydrogen atom reactive with an isocyanate group, such as described in U.S. Pat. No. 4,394,491; hereby incorporated by reference. Examples of such compounds have at least two hydroxyl groups per molecule, and more specifically comprise polyols, such as polyether or polyester polyols. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene—and/or propylene oxide—to form an extended polyester polyol containing additional internal alkyleneoxy groups.

Examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include alaphatic or aromatic amine-based polyols.

Typically, before reacting with a suitable polyisocyanate, the active hydrogen-containing compound described hereinabove and optionally other additives are mixed with the blowing agent cis-1,1,1,4,4,4-hexafluoro-2-butene to form a foam-forming composition. Such foam-forming composition is typically known in the art as an isocyanate-reactive preblend, or B-side composition. The foam-forming composition of this invention can be prepared in any manner convenient to one skilled in this art, including simply weighing desired quantities of each component and, thereafter, combining them in an appropriate container at appropriate temperatures and pressures.

When preparing polyisocyanate-based foams, the polyisocyanate reactant is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of suitable polyisocyanates useful for making polyisocyanate-based foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenylenediisocyanate and 3,3-dimethyoxy-4,4 biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

It is often desirable to employ minor amounts of additives in preparing polyisocyanate-based foams. Among these additives comprise one or more members from the group consisting of catalysts, surfactants, flame retardants, preservatives, colorants, antioxidants, reinforcing agents, filler, antistatic agents, among others well known in this art.

Depending upon the composition, a surfactant can be employed to stabilize the foaming reaction mixture while curing. Such surfactants normally comprise a liquid or solid organosilicone compound. The surfactants are employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. blowing agents+active hydrogen-containing compounds+polyisocyanates+additives) are used. In another embodiment of this invention, about 1.5% to about 3% by weight of surfactant based on the total weight of all foaming ingredients are used.

One or more catalysts for the reaction of the active hydrogen-containing compounds, e.g. polyols, with the polyisocyanate may be also employed. While any suitable urethane catalyst may be employed, specific catalyst comprise tertiary amine compounds and organometallic compounds. Exemplary such catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients.

In the process of the invention for making a cryogenic insulation foam, an active hydrogen-containing compound (e.g. polyol), polyisocyanate and other components are contacted, thoroughly mixed, and permitted to expand and cure into a cellular polymer, either in a mold or poured/filled into a space surrounding a container or pipe. The mixing apparatus is not critical, and various conventional types of mixing head and spray apparatus are used. By conventional apparatus is meant apparatus, equipment, and procedures conventionally employed in the preparation of isocyanate-based foams in which conventional isocyanate-based foam blowing agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents? Processing Technologies for Both Alternatives, Presented by the Equipment Manufacturer”, published in Polyurethanes World Congress 1991 from the Proceedings of the SPI/ISOPA Sep. 24-26, 1991, Acropolis, Nice, France.

In one embodiment of this invention, a preblend of certain raw materials is prepared prior to reacting the polyisocyanate and active hydrogen-containing components. For example, it is often useful to blend the polyol(s), blowing agent, surfactant(s), catalysts(s) and other foaming ingredients, except for polyisocyanates, and then contact this blend with the polyisocyanate. Alternatively, all the foaming ingredients may be introduced individually to the mixing zone where the polyisocyanate and polyol(s) are contacted. It is also possible to pre-react all or a portion of the polyol(s) with the polyisocyanate to form a prepolymer.

The invention composition and processes are applicable to the production of all kinds of expanded polyurethane foams, including, for example, integral skin, RIM and flexible foams, and in particular rigid closed-cell polymer foams useful in spray insulation, as pour-in-place appliance foams, or as rigid insulating board stock and laminates. The invention also includes flexible foam sheets to insulate pipes, joints and for containers holding or transporting cryogenic materials.

The present invention also relates to the closed-cell polyurethane or polyisocyanurate polymer foams prepared from reaction of effective amounts of the foam-forming composition of this disclosure and a suitable polyisocyanate.

### EXAMPLES

The present disclosure is further described in the following Examples. It should be understood that these Examples, while indicating preferred embodiments, are given by way of illustration only. From the above discussion and these Examples, one skilled in the art can ascertain the preferred features, and without departing from the spirit and scope thereof, can make various changes and modifications to adapt it to various uses and conditions.

Polyether polyol Voranol 490 used is a sucrose/glycerine initiated polyether polyol purchased from Dow Chemicals Inc. at Midland, Mich., 49641-1206. It has viscosity of about 500 centerpoise at 25° C. The content of hydroxyl groups is equivalent to about 490 mg KOH per gram of the Polyol.

Polyester polyol Stepanpol PS2502-A is an aromatic polyester polyol purchased from STEPAN Inc. at 22W Frontage Road, Northfield, Ill. 60093. The polyol has viscosity of 3,000 centerpoise at 25° C. The content of hydroxyl groups in Polyol A is equivalent to 240 mg KOH per gram of Polyol.

The surfactant Dabco DC193 is a silicon type surfactant, specifically a polysiloxane purchased from Air Products Inc. at 7201 Hamilton Blvd, Allentown Pa. 18195.

NIAX Silicone L-6900 is a surfactant comprising 60-90% siloxane polyalkyleneoxide copolymer and 10-30% polyalkylene oxide available from Momentive Performance Materials.

The catalyst Potassium HEX-CEM 977, is a potassium catalyst, which contains 25 wt % diethylene glycol and 75 wt % potassium 2-ethylhexanoate, and is purchased from OMG Americas Inc. at 127 Public Square, 1500 Key Tower, Cleveland, Ohio 44114.

The amine based catalyst, Dabco TMR-30, is Tris-2,4,6-(dimethylaminomethyl)phenol purchased from Air Products Inc. at 7201 Hamilton Blvd, Allentown Pa. 18195.

Amine catalyst Polycat 8 is N,N-dimethylcyclohexylamine purchased from Air Products Inc. at 7201 Hamilton Blvd, Allentown Pa. 18195.

Amine catalyst Polycat 5 is Pentamethyldiethylenetriamine purchased from Air Products Inc. at 7201 Hamilton Blvd, Allentown Pa. 18195.

Co-catalyst Dabco TMR31 is purchased from Air Products Inc. at 7201 Hamilton Blvd, Allentown Pa. 18195.

Additive Dabco® PM300 used is 2-Butoxyethanol purchased from Air Products Inc. at 7201 Hamilton Blvd, Allentown Pa. 18195.

The isocyante PAPI 580N and PAPI 27 are polymethylene polyphenyl isocyanates, purchased from Dow Chemicals, Inc. at Midland, Mich., 49641-1206.

Initial k-factor is measured by a LaserComp LT200 Thermal Conductivity Meter at a mean temperature of −165° C. (−265° F.) using Test Method ASTM C518 (ISO 8301). The unit of k-factor is W/mK.

### Example 1

### Polyurethane foam made using cis-1,1,1,4,4,4-hexafluoro-2-butene as blowing agent

Polyol, surfactant and catalysts were premixed by hand and then mixed with the blowing agent. The resulting mixture was mixed with polyisocyanate and poured into a 10″×10″×2.5″ paper box to form the polyurethane foam. The formulation and properties of the foam are shown in Tables 1.

TABLE 1
Foam Using cis-1,1,1,4,4,4-hexafluoro-2-butene blowing agent

| Component | Parts by weight |
|---|---|
| Polyester polyol Stepanpol PS2502-A | 100 |
| Silicon type surfactant Dabco DC193 | 6.17 |
| Catalyst Potassium HEX-CEM 977 | 2.75 |
| Co-catalyst Dabco TMR-30 | 0.68 |
| cis-1,1,1,4,4,4-hexafluoro-2-butene blowing agent | 39.7 |
| Polymethylene polyphenyl isocyanate PAPI 580N | 158 |
| Foam Index | 2.5 |
| Foam density (pounds-per-cubic-feet) | 2.4 |
| Initial K-factor (W/mK at −165 C.) | 0.0108 |

### Example 2

### Polyurethane foam made using 1-chloro-3,3,3-trifluoro-1-propene as blowing agent

Polyol, surfactant and catalysts were premixed by hand and then mixed with blowing agent. Equal moles of 1-chloro-3,3,3-trifluoro-1-propene was used to substitute cis-1,1,1,4,4,4-hexafluoro-2-butene as blowing agent. The resulting mixture was mixed with polyisocyanate and poured into a 10″×10″×2.5″ paper box to form the polyurethane foam. The formulation and properties of the foam are shown in Tables 2.

TABLE 2
Foam using 1-chloro-3,3,3-trifluoro-1-propene blowing agent

| Component | Parts by weight |
|---|---|
| Polyester polyol Stepanpol PS2502-A | 100 |
| Silicon type surfactant Dabco DC193 | 6.17 |
| Catalyst Potassium HEX-CEM 977 | 2.75 |
| Co-catalyst Dabco TMR-30 | 0.68 |
| 1-chloro-3,3,3-trifluoro-1-propene blowing agent | 31.5 |
| Polymethylene polyphenyl isocyanate PAPI 580N | 158 |
| Foam Index | 2.5 |
| Foam density (pounds-per-cubic-feet) | 2.3 |
| Initial K-factor (W/mK at −165 C.) | 0.0102 |

### Example 3

### Polyurethane Foam Made Using Cyclopentane as Blowing Agent

Polyol, surfactant and catalysts were premixed by hand and then mixed with blowing agent. Equal moles of cyclopentane was used to substitute cis-1,1,1,4,4,4-hexafluoro-2-butene as blowing agent. The resulting mixture was mixed with polyisocyanate and poured into a 10″×10″×2.5″ paper box to form the polyurethane foam. The formulation and properties of the foam are shown in Tables 3.

TABLE 3
Foam using cyclopentane blowing agent

| Component | Parts by weight |
|---|---|
| Polyester polyol Stepanpol PS2502-A | 100 |
| Silicon type surfactant Potassium HEX-CEM 977 | 6.17 |
| Catalyst Potassium HEX-CEM 977 | 2.75 |
| Co-catalyst Dabco TMR-30 | 0.68 |
| Cyclopentane blowing agent | 17 |
| Polymethylene polyphenyl isocyanate PAPI 580N | 158 |
| Foam Index | 2.5 |
| Foam density (pounds-per-cubic-feet) | 2.3 |
| Initial K-factor (W/mK at −165 C.) | 0.0109 |

### Example 4

### Polyurethane Foam Made Using Methyl Formate as Blowing Agent

Polyol, surfactant and catalysts were premixed by hand and then mixed with blowing agent. Equal moles of methyl formate was used to substitute cis-1,1,1,4,4,4-hexafluoro-2-butene as blowing agent. The resulting mixture was mixed with polyisocyanate and poured into a 10″×10″×2.5″ paper box to form the polyurethane foam. The formulation and properties of the foam are shown in Tables 4.

TABLE 4
Foam using methyl formate blowing agent

| Component | Parts by weight |
|---|---|
| Polyester polyol Stepanpol PS2502-A | 100 |
| Silicon type surfactant Potassium HEX-CEM 977 | 6.17 |
| Catalyst Potassium HEX-CEM 977 | 2.75 |
| Co-catalyst Dabco TMR-30 | 0.68 |
| Methyl Formate | 14.5 |
| Polymethylene polyphenyl isocyanate PAPI 580N | 158 |
| Foam Index | 2.5 |
| Foam density (pounds-per-cubic-feet) | 2.5 |
| Initial K-factor (W/mK at −165 C.) | 0.0121 |

### Example 5

### Polyurethane foam made using 80 weight % cis-1,1,1,4,4,4-hexafluoro-2-butene and 20 weight % methyl formate as blowing agent

Blowing agent blend was prepared by mixing 80 weight % cis-1,1,1,4,4,4-hexafluoro-2-butene and 20 weight % methyl formate in a glass bottle. Equal moles of blowing agent blend was used to substitute cis-1,1,1,4,4,4-hexafluoro-2-butene as blowing agent. Polyol, surfactant and catalysts were premixed by hand and then mixed with blowing agent blend. The resulting mixture was mixed with polyisocyanate and poured into a 10″×10″×2.5″ paper box to form the polyurethane foam. The formulation and properties of the foam are shown in Tables 5.

The foam using cis-1,1,1,4,4,4-hexafluoro-2-butene and methyl formate blend reduced k-factor by 3% compared to the foam using methyl formate in Example 4. This is expected since cis-1,1,1,4,4,4-hexafluoro-2-butene is a more effective blowing agent compared to methyl formate. The foam using cis-1,1,1,4,4,4-hexafluoro-2-butene showed 11% lower k-factor compared to the foam using methyl formate (0.0108 W/mK in Example 1 compared to 0.0121 W/mK in Example 4). The addition of 80 weight % more effective blowing agent to a less effective blowing agent reduces the k-factor.

TABLE 5
Foam using 80 weight % cis-1,1,1,4,4,4-hexafluoro-2-butene
and 20 weight % methyl formate as blowing agent

| Component | Parts by weight |
|---|---|
| Polyester polyol Stepanpol PS2502-A | 100 |
| Silicon type surfactant Dabco DC193 | 6.17 |
| Catalyst Potassium HEX-CEM 977 | 2.75 |
| Co-catalyst Dabco TMR-30 | 0.68 |
| 80 weight % cis-1,1,1,4,4,4-hexafluoro-2-butene | 29.5 |
| and 20 weight % methyl formate as blowing agent | |
| Polymethylene polyphenyl isocyanate PAPI 580N | 158 |
| Foam Index | 2.5 |
| Foam density (pounds-per-cubic-feet) | 2.1 |
| Initial K-factor (W/mK at −165 C.) | 0.0117 |

### Example 6

### Polyurethane foam made using 80 weight % cis-1,1,1,4,4,4-hexafluoro-2-butene and 20 weight % 1-chloro-3,3,3-trifluoro-1-propene as blowing agent

Blowing agent blend was prepared by mixing 80 weight % cis-1,1,1,4,4,4-hexafluoro-2-butene and 20 weight % 1-chloro-3,3,3-trifluoro-1-propene in a glass bottle. Equal moles of blowing agent blend was used to substitute cis-1,1,1,4,4,4-hexafluoro-2-butene as blowing agent. Polyol, surfactant and catalysts were premixed by hand and then mixed with blowing agent blend. The resulting mixture was mixed with polyisocyanate and poured into a 10″×10″×2.5″ paper box to form the polyurethane foam. The formulation and properties of the foam are shown in Tables 6.

The foam using cis-1,1,1,4,4,4-hexafluoro-2-butene and 1-chloro-3,3,3-trifluoro-1-propene blend showed little change in k-factor compared to the foam using 1-chloro-3,3,3-trifluoro-1-propene in Example 2. This is unexpected since cis-1,1,1,4,4,4-hexafluoro-2-butene is a less effective blowing agent compared to 1-chloro-3,3,3-trifluoro-1-propene. Foam using cis-1,1,1,4,4,4-hexafluoro-2-butene showed 6% higher k-factor compared to the foam using 1-chloro-3,3,3-trifluoro-1-propene (0.0108 W/mK in Example 1 compared to 0.0102 W/mK in Example 2). The addition of 80 weight % less effective blowing agent to a more effective blowing agent with no impact on the k-factor is a surprising finding.

TABLE 6
Foam using 80 weight % cis-1,1,1,4,4,4-hexafluoro-
2-butene and 20 weight % 1-chloro-3,3,3-trifluoro-
1-propene blend as blowing agent

| Component | Parts by weight |
|---|---|
| Polyester polyol Stepanpol PS2502-A | 100 |
| Silicon type surfactant Dabco DC193 | 6.17 |
| Catalyst Potassium HEX-CEM 977 | 2.75 |
| Co-catalyst Dabco TMR-30 | 0.68 |
| 80 weight % cis-1,1,1,4,4,4-hexafluoro-2-butene | 37.7 |
| and 20 weight % 1-chloro-3,3,3-trifluoro-1-propene | |
| blend | |
| Polymethylene polyphenyl isocyanate PAPI 580N | 158 |
| Foam Index | 2.5 |
| Foam density (pounds-per-cubic-feet) | 2.1 |
| Initial K-factor (W/mK at −165 C.) | 0.0103 |

### Example 7

### Polyurethane foam made using 80 weight % cis-1,1,1,4,4,4-hexafluoro-2-butene and 20 weight % cyclopentane as blowing agent

Blowing agent blend was prepared by mixing 80 weight % cis-1,1,1,4,4,4-hexafluoro-2-butene and 20 weight % cyclopentane in a glass bottle. Equal moles of blowing agent blend was used to substitute cis-1,1,1,4,4,4-hexafluoro-2-butene as blowing agent. Polyol, surfactant and catalysts were premixed by hand and then mixed with blowing agent blend. The resulting mixture was mixed with polyisocyanate and poured into a 10″×10″×2.5″ paper box to form the polyurethane foam. The formulation and properties of the foam are shown in Tables 7.

The foam using cis-1,1,1,4,4,4-hexafluoro-2-butene and cyclopentane blend reduced k-factor by 4% compared to the foam using cyclopentane in Example 3. This is unexpected since cis-1,1,1,4,4,4-hexafluoro-2-butene has the same effectiveness compared to cyclopetane. Foam using cis-1,1,1,4,4,4-hexafluoro-2-butene showed almost the same k-factor compared to the foam using cyclopentane (0.0108 ft²-hr-° F./BTU-in in Example 1 compared to 0.0109 W/mK in Example 3).

The addition of 80 weight % blowing agent with the same effectiveness improved k-factor by 4% is a surprising finding.

TABLE 7
Foam using 80 weight % cis-1,1,1,4,4,4-hexafluoro-2-
butene and 20 weight % cyclopentane as blowing agent

| Component | Parts by weight |
|---|---|
| Polyester polyol Stepanpol PS2502-A | 100 |
| Silicon type surfactant Dabco DC193 | 6.17 |
| Catalyst Potassium HEX-CEM 977 | 2.75 |
| Co-catalyst Dabco TMR-30 | 0.68 |
| 80 weight % cis-1,1,1,4,4,4-hexafluoro-2-butene | 31.3 |
| and 20 weight % cyclopenatne blend | |
| Polymethylene polyphenyl isocyanate PAPI 580N | 158 |
| Foam Index | 2.5 |
| Foam density (pounds-per-cubic-feet) | 2.4 |
| Initial K-factor (W/mK at −165 C.) | 0.0105 |

### Example 8

### Polyurethane foam made using 50 weight % trans-1,1,1,4,4,4-hexafluoro-2-butene and 50 weight % cis-1,1,1,4,4,4-hexafluoro-2-butene as blowing agents

Blowing agent blend is prepared by mixing 50 weight % cis-1,1,1,4,4,4-hexafluoro-2-butene and 50 weight % cis-1,1,1,4,4,4-hexafluoro-2-butene in a glass bottle. The bottle is cooled in dry ice for 15 min for minimize the loss of blowing agent mixture. Polyol, surfactant and catalysts are premixed by hand and then mixed with blowing agent blend. The resulting mixture is mixed with polyisocyanate and poured into a 10″×10″×2.5″ paper box to form the polyurethane foam. The formulation and properties of the foam are shown in Tables 8.

TABLE 8
Foam using cis-1,1,1,4,4,4-hexafluoro-2-butene and trans-
1,1,1,4,4,4-hexafluoro-2-butene blend as blowing agent.

| Component | Parts by weight |
|---|---|
| Polyether polyol Voranol 490 | 50 |
| Polyester polyol Stepanpol PS2502-A | 50 |
| Surfactant NIAX Silicone L-6900 | 1.5 |
| Amine catalyst Polycat 8 | 3 |
| Amine catalyst Polycat 5 | 0.38 |
| Co-catalyst Dabco TMR31 | 0.5 |
| Additive Dabco ® PM300 | 4.0 |
| 50 weight % trans-1,1,1,4,4,4-hexafluoro-2-butene | 10 |
| and 50 weight % cis-1,1,1,4,4,4-hexafluoro-2- | |
| butene | |
| Polymethylene polyphenyl isocyanate Papi 27 | 158 |
| Foam Index | 1.1 |
| Foam density (pounds-per-cubic-feet) | 7.7 |
| Initial K-factor (W/mK at −165 C.) | 0.0156 |

What is claimed is:

1. A cryogenic insulation foam consisting of a polyurethane foam, said polyurethane foam comprising a blowing agent, wherein the blowing agent comprises a fluoroolefin.

2. The cryogenic insulation of claim 1, where the fluoroolefin is 1,1,1,4,4,4-hexafluoro-2-butene or trans-1-chloro-3,3,3-trifluoro-1-propene.

3. The cryogenic insulation of claim 2 wherein the blowing agent further comprises a hydrocarbon.

4. The cryogenic insulation foam of claim 3, wherein the hydrocarbon is methyl formate, n-pentane, isopentane, or cyclopentane.

5. The cryogenic insulation foam of claim 1, wherein the polyurethane foam is made from a polyester or polyether polyol.

6. The cryogenic insulation foam of claim 1, 2, 3, or 4, wherein said foam is in a sheet.

7. The cryogenic insulation foam of claim 1, wherein the blowing agent comprises 1,1,1,4,4,4-hexafluoro-2-butene and 1-chloro-3,3,3-trifluoro-1-propene.

8. The cryogenic insulation foam of claim 1, wherein the 1-chloro-3,3,3-trifluoro-1-propene is from 0.1 to 100 weight percent of the blowing agent.

9. The cryogenic insulation foam of claim 8, wherein the 1-chloro-3,3,3-trifluoro-1-propene is from 10 to 90 weight percent of the blowing agent.

10. The cryogenic insulation foam of claim 7, wherein the 1-chloro-3,3,3-trifluoro-1-propene is from 1 to 99 weight percent of the blowing agent, and the 1,1,1,4,4,4-hexafluoro-2-butene is from 99 to 1 weight percent of the blowing agent.

11. The cryogenic insulation foam of claim 1, wherein the 1,1,1,4,4,4-hexafluoro-2-butene is from 0.1 to 100 weight percent of the blowing agent.

12. The cryogenic insulation foam of claim 8, wherein the 1,1,1,4,4,4-hexafluoro-2-butene is from 10 to 90 weight percent of the blowing agent.

13. The cryogenic insulation foam of claim 7, wherein the 1-chloro-3,3,3-trifluoro-1-propene is from 1 to 99 weight percent of the blowing agent, and the 1,1,1,4,4,4-hexafluoro-2-butene is from 99 to 1 weight percent of the blowing agent.
